(19) United States
(12) Patent Application Publication
(10) Pub. No.: US 2011/0320504 A1
(43) Pub. Date: Dec. 29, 2011

(54) MODELING FOR EVENT ENABLED CONTENT MANAGEMENT SYSTEMS

(75) Inventor: Mike A. Marin, Laguna Hills, CA (US)

(73) Assignee: INTERNATIONAL BUSINESS MACHINES CORPORATION, Armonk, NY (US)

(21) Appl. No.: 12/825,329

(22) Filed: Jun. 28, 2010

(51) Int. Cl. G06F 17/30; G06F 3/048

(52) U.S. Cl. 707/805; 707/E17.005

(57) ABSTRACT

Provided are techniques for, in response to user input, creating a model that includes at least one icon representing a content object and an event line representing an event, wherein the event has an associated action; configuring a content management system using the model; and, in response to the event being raised, performing the action.

### BACKGROUND

1. Field

Embodiments of the invention relate to modeling for event enabled content management systems.

2. Description of the Related Art

A content management system (CMS) (also known as an enterprise content management system (ECMS)) may be described as a software system used to store and manage content objects in a computer system. The content objects stored and managed by the content management system consist of any type of computer files in any computer readable format, including text files, documents, picture files, video files, sound files, etc. In addition to files, the content management system may also manage other types of objects, including folders, versions, etc. In general, the files and other objects are called content objects. The content management system can maintain multiple versions of the content objects managed and meta-data for each content object. The content management system allows users (e.g., humans and machines) to create, access, modify, and delete content objects, among other operations. For content objects, such as files, the object repository contains metadata including the one or more locations of content elements that represent the actual content (e.g., text of a document object). The content elements may be stored in a separate storage repository, outside of the content management system.

Content management applications are applications built using a content management system. For example, a vendor may sell a content management system, and the buyer may build a management application to solve a business problem using the content management system. A content management application is composed of one or more programs.

Implementing and deploying content management applications, programs or business processes to work with a content management system is a difficult task that requires configuring several aspects of the content management system, including defining all the objects to interact with end users and external components, such as programs. The problem is compounded in an event enabled content management system because of the additional event handling configuration that is required. Typically, a system administrator or other user manually configures the content management system to specify what action should take place when a particular event occurs. The action may be to notify a program of the event, to create a content object or any other action supported by the content management system (using tools provided by the content management system). Such manual configuration is error prone.

Currently, the task of deployment and configuration of content management applications, programs and business processes in the content management system is done by using configuration tools. In most cases, a methodology is developed in which instructions are provided on paper to describe all the pieces that need to be configured.

Thus, there is a need for modeling for event enabled content management systems.

### BRIEF SUMMARY

Provided are a method, computer program product, and system for, in response to user input, creating a model that includes at least one icon representing a content object and an event line representing an event, wherein the event has an associated action; configuring a content management system using the model; and, in response to the event being raised, performing the action.

### BRIEF DESCRIPTION OF THE SEVERAL VIEWS OF THE DRAWINGS

Referring now to the drawings in which like reference numbers represent corresponding parts throughout:

FIG. 1 illustrates a computing device 100 in accordance with certain embodiments.

FIG. 2 illustrates icons for content objects in accordance with certain embodiments.

FIG. 3 illustrates icons for external components in accordance with certain embodiments.

FIG. 4 illustrates icons for events in accordance with certain embodiments.

FIG. 5 illustrates other icons in accordance with certain embodiments.

FIG. 6 illustrates an empty drawing canvas of a configuration modeling tool in accordance with certain embodiments.

FIG. 7 illustrates addition of a source content object in accordance with certain embodiments.

FIG. 8 illustrates addition of an event in accordance with certain embodiments.

FIG. 9 illustrates addition of a target content object in accordance with certain embodiments.

FIG. 10 illustrates addition of an external component in accordance with certain embodiments.

FIG. 11 illustrates addition of another event in accordance with certain embodiments.

FIG. 12 illustrates a model in accordance with certain embodiments.

FIG. 13 illustrates logic for configuring an event driven CMS in accordance with certain embodiments.

FIG. 14 illustrates a computer architecture that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

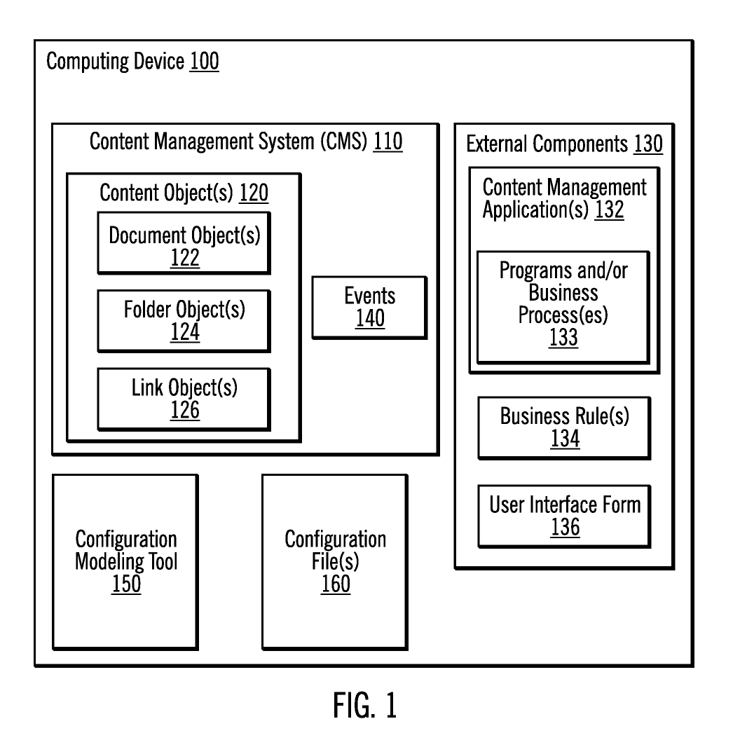

FIG. 1 illustrates a computing device 100 in accordance with certain embodiments. The computing device 100 includes a content management system (CMS) 110, external components 130, a configuration modeling tool 150, and one or more configuration files 160.

The content management system 110 includes content objects 120 and events 140. The configuration modeling tool 150 provides a user interface to enable a user to configure the content management system 110 to define what events 140 are of interest and what action to take when those events 140 take place.

With embodiments, the content management system 110 stores multiple types of content objects 120 organized into at least the following types:

1. Document objects 122. In this context, a document may be described as any type of digital object or computer file in any computer readable format, including text files, documents, picture files, video files, sound files, etc. There may be multiple versions of a document object 122.

2. Folder objects 124 (also referred to as container objects) (e.g., to store content objects and other folder objects). Folder objects 124 provide a way to organize the documents and other folder objects 124.

3. Link objects 126 (also referred to as relationships objects). Link objects 126 allow users of the content management system 110 to create relationships between any type of content objects 120 (including other link objects 126, document objects 122, and folder objects 124) in the content management system 110.

Embodiments include other types of objects 120 as well, such as checklist objects, which are described in CONTENT MANAGEMENT CHECKLIST OBJECT, filed on, having application Ser. No. ______. That is, the objects 122, 124, 126 are not exhaustive and other objects may be included in the one or more content objects 120.

The content management system 110 allows users (e.g., humans and machines) to create, access, modify, and delete content objects 120, among other operations.

The external components 130 include one or more content management applications 132 composed of one or more programs and/or business processes 133, one or more business rules 134, and one or more user interface form(s) 136. The external components 130 may also include other external components in various embodiments.

The configuration modeling tool 150 simplifies the tasks in configuring and deploying content management applications, programs and business processes in the content management system 110. The configuration modeling tool 150 enables a user to describe all or most of the content management system configuration, including content objects 120 and events 140, in an intuitive manner. The configuration modeling tool 150 may be described as a single visual editor tool.

The configuration modeling tool 150 improves and simplifies the tasks of implementing and deploying content management applications, programs and/or processes in the content management system 110 by allowing users to visually draw the configuration in a graphical tool.

The configuration modeling tool 150 uses icons to represent the content objects 120 and external components (one or more content management applications 132, programs and/or business processes 133, business rules 134, user interface forms 136 etc.), and lines to represent events 140 being configured. This simplifies the configuration and deployment of applications 132, programs and/or business processes 133. The configuration modeling tool 150 allows a user to describe the configuration required to deploy a content management application 132, program and/or business process 133. The task of drawing the configuration required to deploy a content management application, program and/or business process is called modeling. The output of modeling is a configuration file 160, which may be encoded in eXtensible Markup Language (XML) or any other textual or binary representation. The configuration modeling tool 150 or another tool may then use the configuration file 160 to automatically configure the content management system 110.

In certain embodiments, a different icon is used to represent each different type of object 122, 124, 126. In addition, other content objects 120 may also be represented by creating additional icons. For example, an icon for a checklist object may be provided.

Also, the external components 130 are represented by icons. Most content management applications 132 and/or programs and/or business processes 133 involve the interaction of the content objects 120 with the external components 130.

Events 140 in the content management system 110 are used to indicate creation or changes in the content objects 120. In the content management system 110, most content management applications 132 and/or programs and/or business processes 133 are configured to receive and react to these events 140. With embodiments, events 140 are represented by lines that connect the content object 120 that is generating or causing the event 140 to be raised and the content object 120 or external component 130 that react to the event 140. In certain embodiments, the end or the beginning of the event line graphically indicates the type of action the event 140 is effecting. The attributes of the event 140 are used to indicate the conditions in which the event 140 is to be raised.

Each icon or line has associated attributes that include the configuration in the content management system 110. When an icon is placed in a drawing canvas (e.g., an area provided via a Graphical User Interface (GUI) that is displayed on a screen), the user can then enter the configuration information in the attributes.

For example, some attributes for the different content objects 120, external components 130, and events 140 include a name, a description, and any specific attribute or metadata for the specific entity. The configuration modeling tool 150 collects enough information on the attributes of different content objects 120, external components 130, and events 140 to be able to deploy the model in the content management system 110.

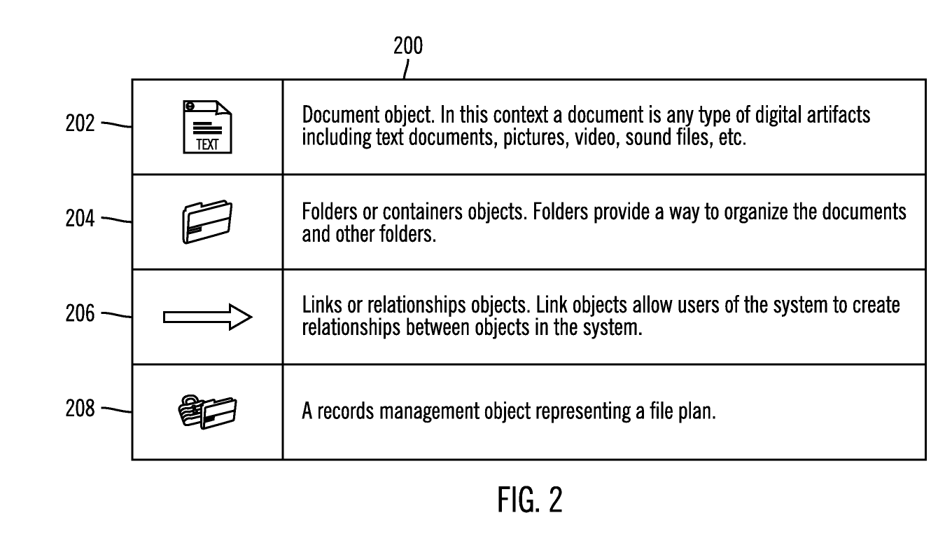

FIGS. 2-5 illustrate tables 200, 300, 400, 500 that describe icons for content objects 120, external components 130, and events 140 in accordance with certain embodiments. The icons used in here are for illustration purposes, and different icons could be used in different embodiments.

Table 200 in FIG. 2 illustrates icons for content objects 120 in accordance with certain embodiments. The icons for content objects 120 include an icon 202 for a document object 122, an icon 204 for a folders object 124, an icon 206 for a link object 126, and an icon 208 for a file plan. A file plan may be used in the content management systems 110 to define retention characteristics for content objects 120 filed in the file plan. For example, some content objects 120 may need to be destroyed five years after their filing into the file plan.

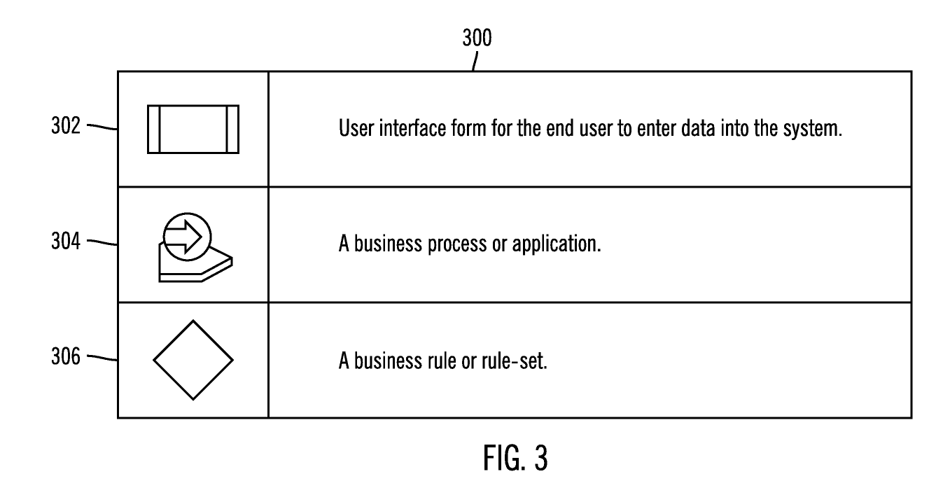

Table 300 in FIG. 3 illustrates icons for external components 130 in accordance with certain embodiments. The icons for external components 130 include an icon 302 for a user interface form 136, an icon 304 for an application 132 or program or business process 133, and an icon 306 for a business rule or rule-set 134.

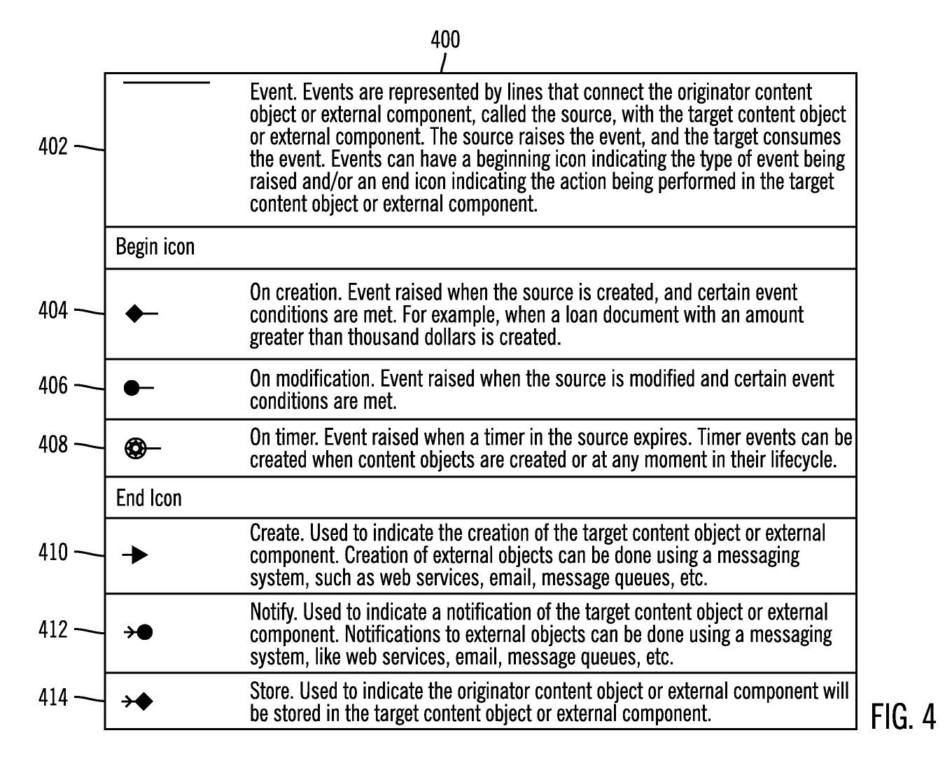

Table 400 in FIG. 4 illustrates icons for events 140 in accordance with certain embodiments. The icons for external components 130 include an icon 402 of a line for an event 140. The line may have begin icons 404, 406, 408, and/or end icons 410, 412, 414 that graphically indicate the type of action the event 140 is effecting. With embodiments, a source may be a content object 120 or an external component 130, and a target may be a content object 120 or an external component 130. An event 140 connects the source and target.

In particular, the begin icon 404 represents an event 140 that is raised on creation of a source; the begin icon 406 represents an event 140 raised on modification of the source; and the begin icon 408 represents an event 140 that is raised when a timer in the source expires. Also, the end icon 410 represents the action of creating a target content object 120 or external component 130; the end icon 412 represents the action of notifying a target content object 120 or external component 130; and the end icon 406 represents the action of storing the originator content into the target content object 120 or external component 130.

The begin icon 404, 406, 408 is attached to the event line at a point of the line that is coupled to a source. The end icon 410, 412, 414 is attached to the event line at a point of the line that is coupled to a target. Any content object 120 or external component 130 may be a source and/or a target. For example, a content object 120 may be a source content object with reference to a first event 140 and may be a target content object 120 with reference to a second event 140.

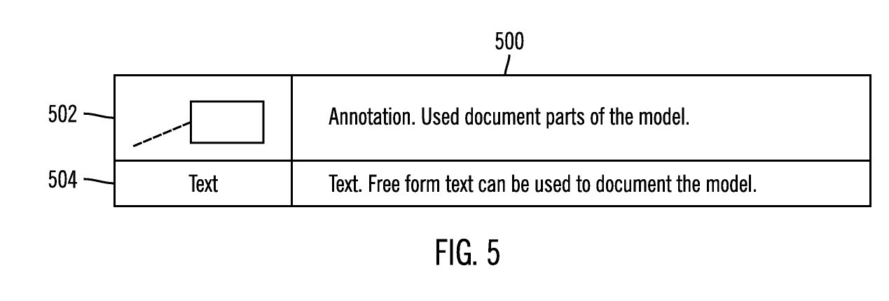

Table 500 in FIG. 5 illustrates other icons in accordance with certain embodiments. The other icons include an icon 502 for annotation, and an icon 504 for text.

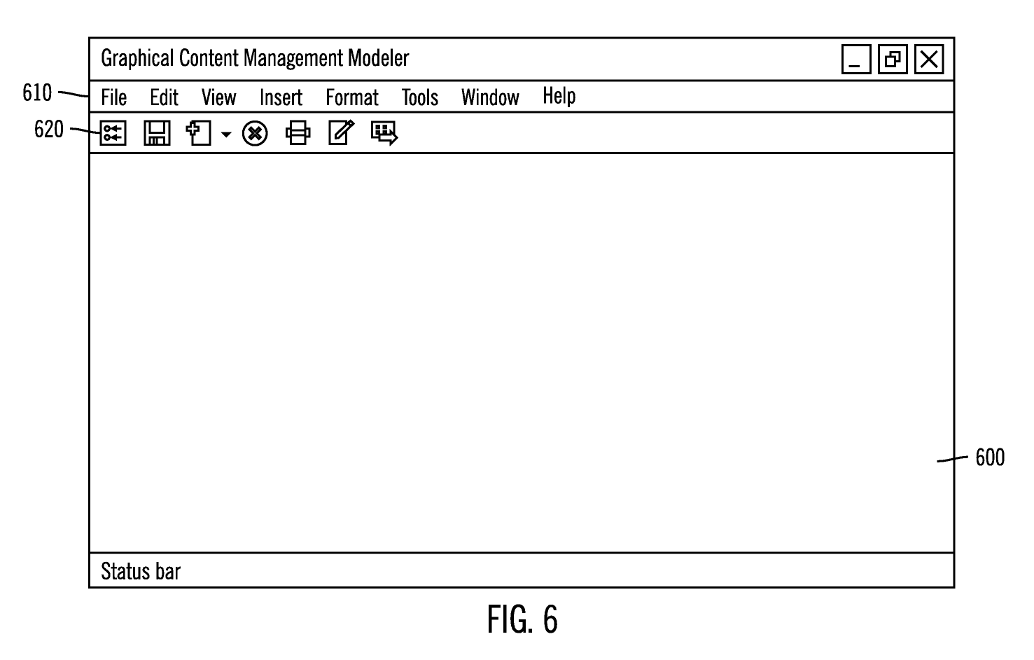

FIGS. 6-11 illustrated an example in which a user configures an content management system 110 with three content objects 120 and two events 140. In certain embodiments, a non-event driven content management system is configured in a similar manner, but without the two events 140.

To start, the user opens (i.e., executes) the configuration modeling tool 150. FIG. 6 illustrates an empty drawing canvas 600 of the configuration modeling tool 150 in accordance with certain embodiments. Menus 610 and icons 620 are displayed above the drawing canvas 600 for easy selection.

The addition of an icon 620 to the drawing canvas 600 operation may be done in multiple ways. For example, a user may drag and drop the icon 620 to the drawing canvas 600 or the user may use a right mouse click in the drawing canvas 600 and select the icon from a list or other structure. After the icon is placed in the drawing canvas 600, the user may configure the characteristics of the object represented by the icon via, for example, a dialog box, property panel, or other form.

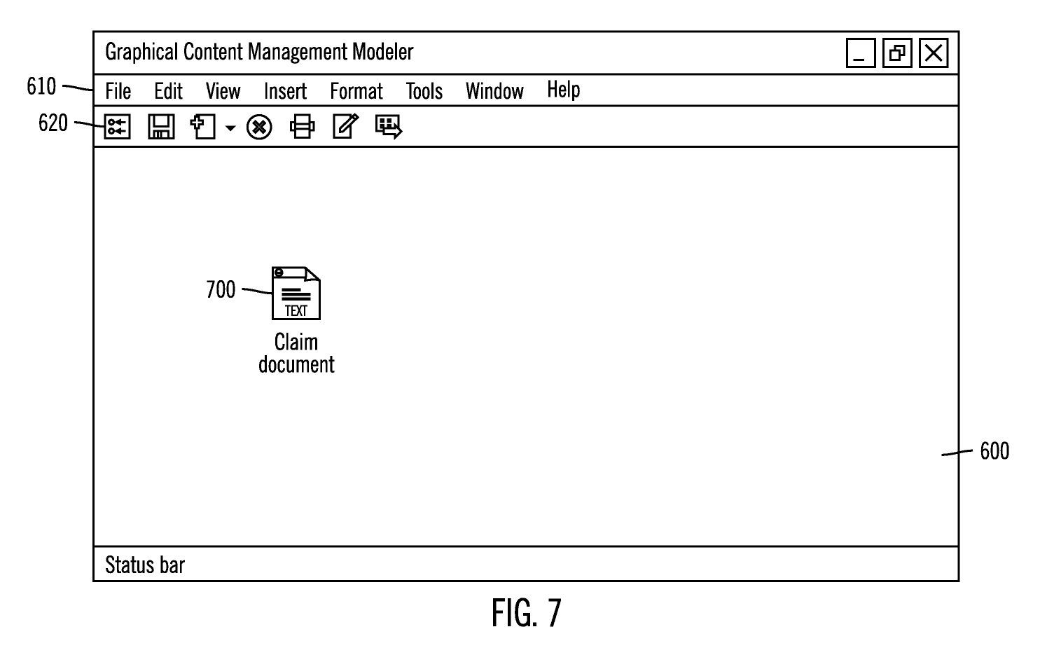

FIG. 7 illustrates addition of a source content object 700 in accordance with certain embodiments. In this example, the user places an icon for the source content object 700 in the drawing canvas 600. In this example, the source content object 700 is a document class. Document objects 122 are instantiations of document classes.

After the icon for the source content object 700 is placed in the drawing canvas 600, the user may configure the characteristics of the source content object 700 via a dialog box, property panel, or other form. In this example, the characteristics of the source content object 700 include the name (i.e., label) of the source content object 700 (“Claim document”), any associated metadata, and potential object inheritance. After this configuration, the drawing canvas 600 shows the source content object 700 as illustrated in FIG. 7.

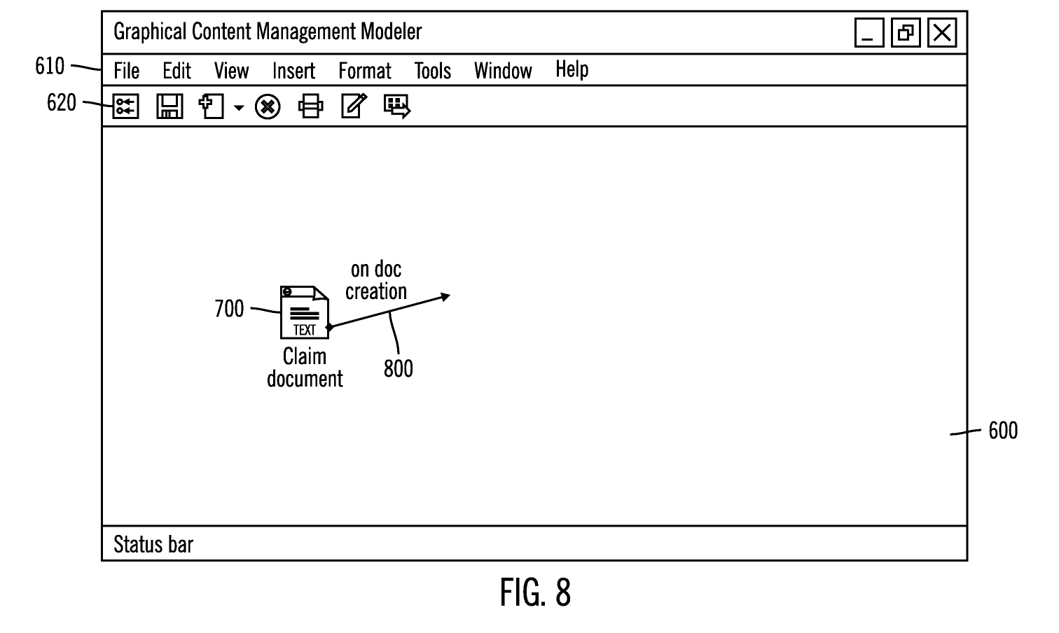

FIG. 8 illustrates addition of an event 800 in accordance with certain embodiments. Continuing with the example, next the user decides to configure a creation event 800 that will trigger when a document of the “claim document” class is created. The user places the event line for the event 800 in the drawing canvas 600 and then configures the event characteristics. In this case, the event selected is a creation event, the name is set to “on doc creation”, and the action to be taken is the creation of another object.

After the event line for the event 800 is placed in the drawing canvas 600, then the user configures the characteristics of the event line 800 via a dialog box, property panel, or other form. In this example, the characteristics of the event 800 include the name (“on doc creation”), any associated metadata, and the type of action to be taken when the event triggers. After this configuration, the drawing canvas 600 shows the event 800 as illustrated in FIG. 8.

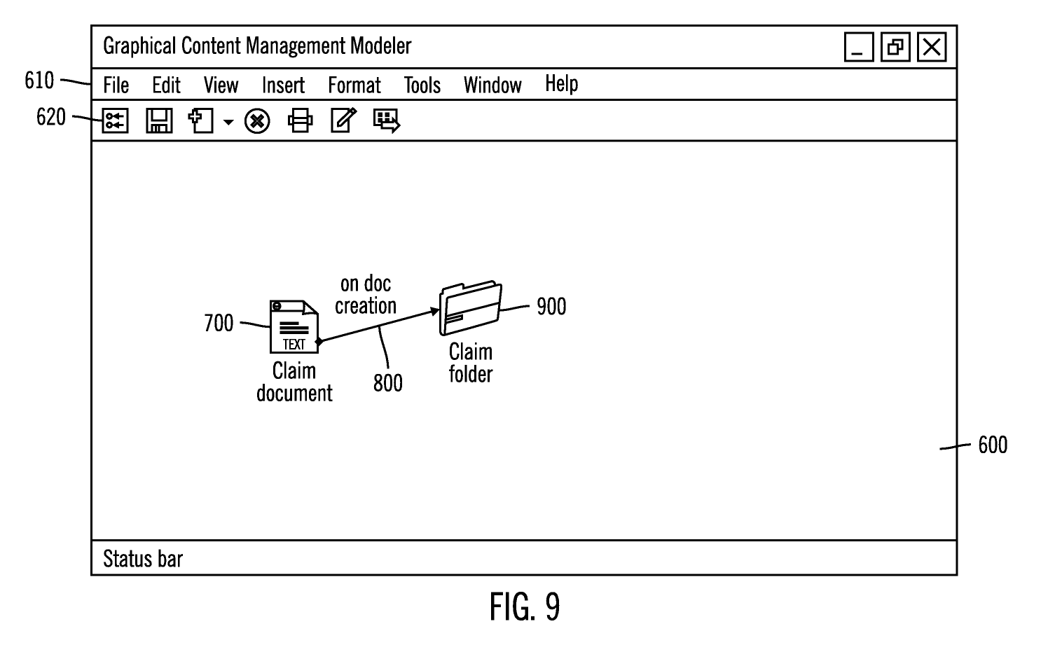

FIG. 9 illustrates addition of a target content object 900 in accordance with certain embodiments. In this example, next, the user decides to place an icon for the target content object 900 in the drawing canvas 600. In this case the folder object name is set to “claim folder”.

After the icon for the target content object 900 is placed in the drawing canvas 600, the user may configure the characteristics of the target content object 900 via a dialog box, property panel, or other form. Similarly to the source content object 700, the user configures the target content object characteristics, including name, metadata, inheritance, etc. In this case, the target content object 900 will be created as the action of the “on doc creation” event 800. The target content object 800 is a folder object. After this configuration, the drawing canvas 600 shows the target content object 900 as illustrated in FIG. 9.

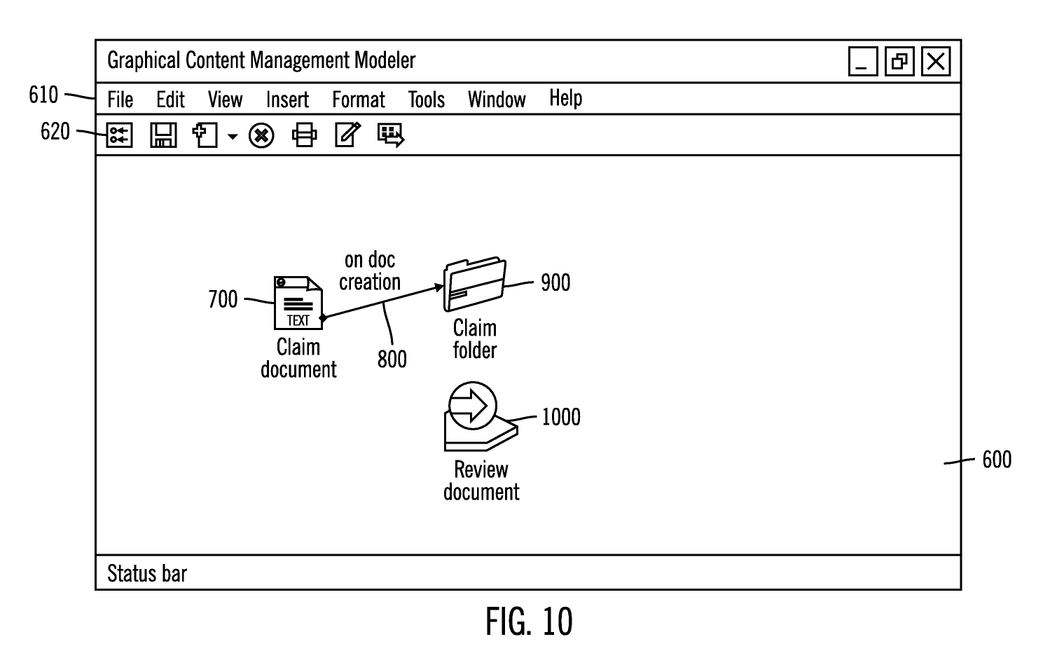

FIG. 10 illustrates addition of an external component 1000 in accordance with certain embodiments. Continuing with the example, the user places an icon for the external component 1000 in the drawing canvas 600. In this case, the external component 1000 is an external application called “Review document”.

After the icon for the external component 1000 is placed in the drawing canvas 600, the user may configure the characteristics of the external component 1000 via a dialog box, property panel, or other form. After this configuration, the drawing canvas 600 shows the external component 1000 as illustrated in FIG. 10.

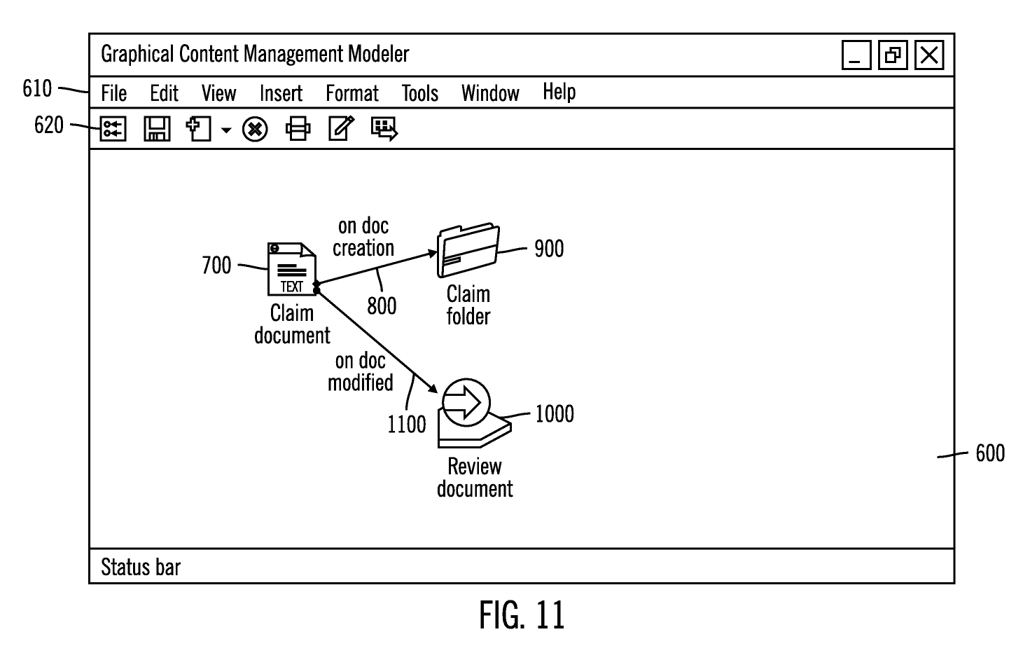

FIG. 11 illustrates addition of another event 1100 in accordance with certain embodiments. Next, in this example, the user places an event line for the event 1100 in the drawing canvas 600. The event 1100 is raised by the instance of the “Claim document” and is configured to start the “Review document” application. The user does part of the configuration by placing in the drawing canvas 600 an event line connecting the “Claim document” class and the “Review document” application. The rest of the event configuration, including which event 1100 is being configured (metadata change in this case), is done via a dialog box, property panel, or other form. The name and/or label of the event is set to “on doc modified”. After this configuration, the drawing canvas 600 shows the event 1100 as illustrated in FIG. 11.

Continuing with the example, optionally, the user deploys the configuration into the content management system 110 using a menu 610 of the configuration modeling tool 150. Alternatively, the user may save the configuration in a configuration file 160 without deploying the configuration. This allows the user to read or open the configuration file 160 in the future to continue configuring the system.

In certain embodiments, the configuration modeling tool 150 applies the configuration implicitly as the user is defining the configuration. In certain alternative embodiments, the configuration modeling tool 150 deploys the configuration explicitly in response to user input.

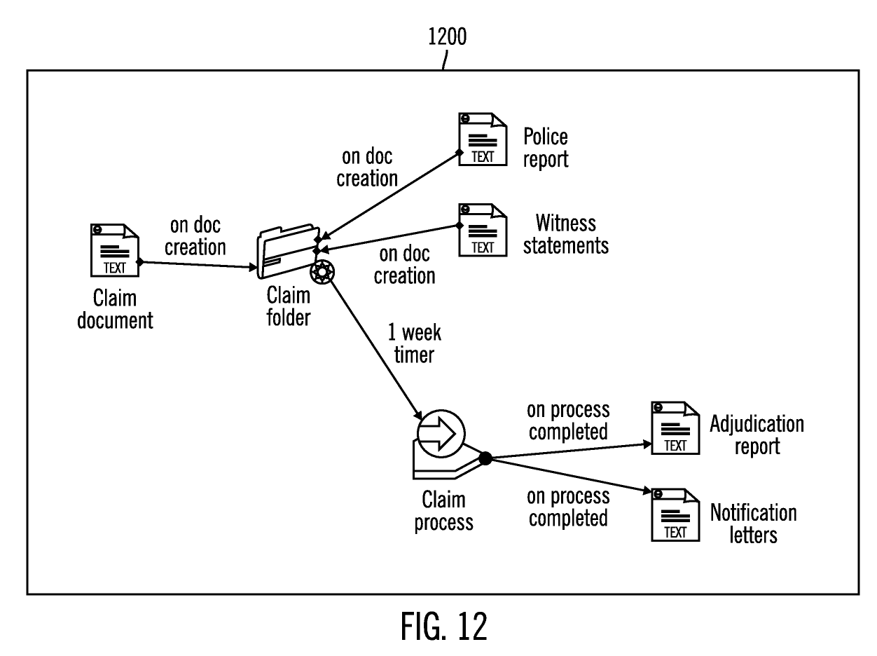

FIG. 12 illustrates a model 1200 in accordance with certain embodiments. FIG. 12 illustrates a visual configuration for a claims processing application implemented in the content management system 110. In this example, the model 1200 shows the graphic resulting from a user drawing the configuration in the drawing canvas of the configuration modeling tool 150. Each icon and line has enough attributes (not shown in the picture) describing the configuration of the represented content object 120, external component 130 or event 140, that will allow the configuration modeling tool 150 to deploy the configuration in the content management system 110.

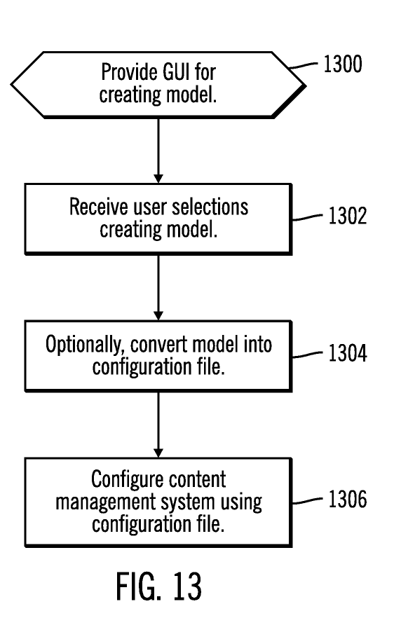

FIG. 13 illustrates logic for configuring an content management system 110 in accordance with certain embodiments. Control begins at block 1300 with the configuration modeling tool 150 providing a GUI to a user for creating a model. In block 1302, the configuration modeling tool 150 receives user selections creating the model. In block 1304, the configuration modeling tool 150 optionally converts the model into configuration file 160. In block 1306, the configuration modeling tool 150 configures the content management system 110 using the configuration file 160. In particular, in block 1306, the configuration modeling tool 150 (or a deployment tool) creates all the configuration information in the content management system 110 described in the model, including content object definitions, event definitions, and actions. The end result is that the content management system 110 is configured to behave in the manner described by the model.

Thus, the configuration modeling tool 150 simplifies deployment and system configuration by combining multiple configuration activities into a single modeling activity. The configuration modeling tool 150 further simplifies deployment and system configuration by using a flexible modeling paradigm that uses icons to represent the objects being manipulated. The configuration modeling tool 150 facilitates communication between users involved in the deployment and configuration of content management system applications by providing a visual representation of the application, program and/or business process configuration.

Embodiments provide the configuration modeling tool 150 (i.e., a graphical tool) that allows users to visually draw (model) the configuration in an content management system 110.

Icons are used to represent the content objects 120 and external components 130 and actions, while lines are used to represent events 140. The model may be described as being composed of quadruplets (source content object, event, action, target content object) that are drawn (modeled) as icons representing the content object 120, a line representing the event 140, and the action to be executed when the event 140 happens in the content object 120. The set of quadruplets in the model describes a configuration of the content management system 110, and the model can be used to configure the content management system 110.

In certain embodiments, a minimum a user can configure is a single content object. In certain non-event driven content management systems, there are no events, but embodiments are able to configure the content objects without events (in which case there are no source or target content objects, just content objects).

### Additional Embodiment Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, solid state memory, magnetic tape or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The code implementing the described operations may further be implemented in hardware logic or circuitry (e.g., an integrated circuit chip, Programmable Gate Array (PGA), Application Specific Integrated Circuit (ASIC), etc.

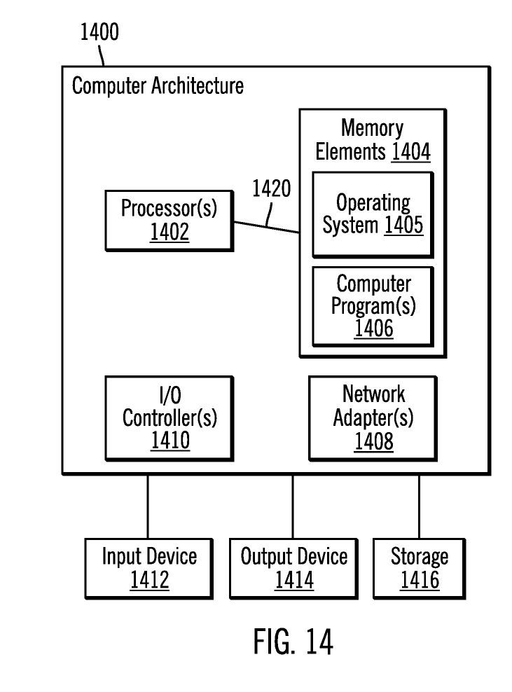

FIG. 14 illustrates a computer architecture 1400 that may be used in accordance with certain embodiments. Computing device 100 may implement computer architecture 1400. The computer architecture 1400 is suitable for storing and/or executing program code and includes at least one processor 1402 coupled directly or indirectly to memory elements 1404 through a system bus 1420. The memory elements 1404 may include local memory employed during actual execution of the program code, bulk storage, and cache memories which provide temporary storage of at least some program code in order to reduce the number of times code must be retrieved from bulk storage during execution. The memory elements 1404 include an operating system 1405 and one or more computer programs 1406.

Input/Output (I/O) devices 1412, 1414 (including but not limited to keyboards, displays, pointing devices, etc.) may be coupled to the system either directly or through intervening I/O controllers 1410.

Network adapters 1408 may also be coupled to the system to enable the data processing system to become coupled to other data processing systems or remote printers or storage devices through intervening private or public networks. Modems, cable modem and Ethernet cards are just a few of the currently available types of network adapters 1408.

The computer architecture 1400 may be coupled to storage 1416 (e.g., a non-volatile storage area, such as magnetic disk drives, optical disk drives, a tape drive, etc.). The storage 1416 may comprise an internal storage device or an attached or network accessible storage. Computer programs 1406 in storage 1416 may be loaded into the memory elements 1404 and executed by a processor 1402 in a manner known in the art.

The computer architecture 1400 may include fewer components than illustrated, additional components not illustrated herein, or some combination of the components illustrated and additional components. For example, computer programs 1406 may include the configuration modeling tool 150 to configure the content management system 110 (potentially using one or more configuration files 160). The computer architecture 1400 may comprise any computing device known in the art, such as a mainframe, server, personal computer, workstation, laptop, handheld computer, telephony device, network appliance, virtualization device, storage controller, etc.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the embodiments, the embodiments reside in the claims hereinafter appended or any subsequently-filed claims, and their equivalents.

1. A method, comprising:
in response to user input, creating a model that includes at least one icon representing a content object and an event line representing an event, wherein the event has an associated action;
configuring a content management system using the model; and
in response to the event being raised, performing the action.

2. The method of claim 1, further comprising:
creating a configuration file using the model.

3. The method of claim 1, wherein the at least one icon representing the content object represents one of a document object, a folder object, a link object or any other object in the content management system.

4. The method of claim 1, wherein the event line has a begin icon attached to the event line at a point of the event line that is coupled to the content object and wherein the begin icon graphically represents the associated action.

5. The method of claim 1, wherein the event line has an end icon attached to the event line at a point of the event line that is coupled to a target content object and wherein the end icon graphically represents an associated action.

6. The method of claim 1, wherein the content object comprises a source content object.

7. The method of claim 1, wherein the content object comprises an external component.

8. A system, comprising:
hardware logic performing operations, the operations comprising:
in response to user input, creating a model that includes at least one icon representing a content object and an event line representing an event, wherein the event has an associated action;
configuring a content management system using the model; and
in response to the event being raised, performing the action

9. The system of claim 8, wherein the operations further comprise:
creating a configuration file using the model.

10. The system of claim 8, wherein the at least one icon representing the content object represents one of a document object, a folder object, a link object or any other object in the content management system.

11. The system of claim 8, wherein the event line has a begin icon attached to the event line at a point of the event line that is coupled to the content object and wherein the begin icon graphically represents the associated action.

12. The system of claim 8, wherein the event line has an end icon attached to the event line at a point of the event line that is coupled to a target content object and wherein the end icon graphically represents an associated action.

13. The system of claim 8, wherein the content object comprises a source content object.

14. The system of claim 8, wherein the content object comprises an external component.

15. A computer program product comprising a computer readable storage medium including a computer readable program, wherein the computer readable program when executed by a processor on a computer causes the computer to:
in response to user input, create a model that includes at least one icon representing a content object and an event line representing an event, wherein the event has an associated action;
configure a content management system using the model; and
in response to the event being raised, perform the action.

16. The computer program product of claim 15, the computer readable program when executed by the processor on the computer causes the computer to:
create a configuration file using the model.

17. The computer program product of claim 15, wherein the at least one icon representing the content object represents one of a document object, a folder object, a link object or any other object in the content management system.

18. The computer program product of claim 15, wherein the event line has a begin icon attached to the event line at a point of the event line that is coupled to the content object and wherein the begin icon graphically represents the associated action.

19. The computer program product of claim 15, wherein the event line has an end icon attached to the event line at a point of the event line that is coupled to a target content object and wherein the end icon graphically represents an associated action.

20. The computer program product of claim 15, wherein the content object comprises a source content object.

21. The computer program product of claim 15, wherein the content object comprises an external component.
